(19) United States
(12) Patent Application Publication
(10) Pub. No.: US 2007/0173315 A1
(43) Pub. Date: Jul. 26, 2007

(54) Method and apparatus for forming a bet or bonus line

(76) Inventor: Steven Law, Hillborough, NJ (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/337,730

(22) Filed: Jan. 23, 2006

(51) Int. Cl. A63F 13/00

(52) U.S. Cl. 463/20

(57) ABSTRACT

The disclosed invention relates to gaming devices and more particularly to an improved method for forming a bet or bonus line used by a probabilistic gaming device to determine a payout. The disclosed probabilistic gaming device uses a number of reels, each of which display a plurality of tiles. A bet-line is formed by selecting a tile from a leading reel, and then selecting a tile from one of the center reels. The bet-line is then comprised of the row of center tiles including the selected center tile, and the selected tile from the leading reel. After selecting a bet-line the player then plays a game; the reels are activated, and a payout is determined by the configuration of the displayed tiles after the reels come to a rest. The final tile configuration is also checked to determine if a bonus line payout is due, where the bonus line may be formed horizontally or vertically.

### FIELD OF THE INVENTION

The present invention relates generally to gaming devices and more particularly to an improved method for forming a bet or bonus line used by a probabilistic gaming device to determine a payout.

### Description of the Prior Art

Probabilistic gaming devices, such as slot machines, have been a cornerstone of the gaming industry for many years. In a typical probabilistic gaming device the player receives a payout, which may be in casino credits or standard currency coins, whenever a certain combination of symbols are displayed on the reels relative to a bet line. To accommodate different players' risk preferences, a casino will usually have groups of probabilistic gaming devices with different minimum wagers. For instance, a casino may have one group of machines with a minimum wager of $5.00 per reel activation, and a separate group of machines with a minimum wager of $0.50 per reel activation. In addition, casino operators may generally adjust the amount of money paid out as a percentage of the money wagered (“payout percentage”). Casino operators make these adjustments based on regulations imposed on them by a governing gaming authority, and on competitive pressures imposed by other casinos. Often, the payout percentage is raised for machines with a higher minimum wager.

In a present probabilistic gaming device, a group of symbols are arranged on a number of different reels, where the reels may be actual mechanical reels but, in modern devices, are more likely to be virtual reels maintained within a computer. Usually, there are two types of arrangements of the reels. Modern probabilistic gaming devices, typically with computer generated virtual reels, will have three or four reels stacked vertically in a column, and there are usually three to five such columns in the layout. Only one symbol on each reel will be dominantly visible and will used as the final result of a position. Another arrangement, which is typical of mechanical systems, has only reel as a column and several consecutive symbols on a reel, which are dominantly visible, are used as the final results for corresponding positions. In this arrangement, a column is comprised of only one reel, and there may be three to five columns in the layout. In either arrangement, each visible position of a final result is known as a tile. Also, for simplicity of communication, a column of reels are usually referred to as one vertical reel even though it may actually be comprised of multiple physical or virtual reels. Therefore, the configuration of FIG. 1 is generally regarded as a four reel device.

A number of factors contribute to the popularity of probabilistic gaming devices. Among these factors are the underlying mechanics of how a bet line can be formed and the use of bonus rounds or bonus games. Present probabilistic gaming devices offer a wide variety of ways that a bet line can be formed. Present probabilistic gaming devices allow players to form bet-lines horizontally, vertically, diagonally, or in a zig-zag pattern, as long as adjacent tiles are touching in some fashion. A greater number of bet-lines are desirable so that the probabilistic gaming device can provide more ways for the player to win based on the number of wagers the player makes per game played. For instance, FIG. 1, which illustrates a prior art system, allows a bet-line to be formed encompassing all four reels in the illustrated zig-zag pattern. To aid players in visualizing their bet-lines, present systems usually have equal numbers of tiles in each reel.

A player receives a payout when a set of symbols appears on the tiles selected by the player for the player's bet-line. Usually, the same symbol in each selected tile in the bet-line results in a payout for the player, but this is not a necessary feature of the prior art systems. For instance, referring again to FIG. 1, if the four selected tiles all displayed a bell, the player would receive a payout. The amount of the payout may also be affected by the particular collection of symbols in the bet-line. For instance, a set of bells may result in a higher payout than a set of hearts or spades.

Bonus rounds or bonus games have also been used in the prior art. A bonus round may take the form of a free spin which is triggered by some predetermined event; for instance a given number of rounds played. Bonus rounds may also be triggered randomly. In addition, bonus rounds may be a different form of random game altogether; for instance, a bonus round may take the form of the popular “whack-a-mole” game, where the player must guess where the mole will appear in advance.

To form a large number of bet-lines presently available systems rely to a great extent on diagonal and zig-zag pattern bet-lines. Unfortunately, these patterns are difficult for the player to visualize and follow no predicted order for formation of a bet-line. These factors combine to result in players selecting these bet-lines less often.

Also, present systems are limited to an equal number of tiles in each column, which limits the visual presentation of the probabilistic gaming device.

Also, present systems utilize bonus rounds or bonus games which take place separately from the wagered games. Therefore, the player risks nothing during the bonus round or bonus game, which lowers the number of wagers the player will place in a given period of time.

### Objects of the Invention

Accordingly, one object of the invention is to provide a large number of easily visualizable bet-lines, thereby increasing the average number of bet-lines wagered per game, and resulting in a larger profit for the operator.

Another object of the invention is to provide a probabilistic gaming device where bet-lines are easily visualizable by the player, but the number of tiles per reel may vary, thereby providing added novelty to the game.

Another object of the invention is to provide a bonus-line, which provides the player with an additional opportunity for a payout during each wagered game, thereby reducing or eliminating games where the player risks nothing, and resulting in a larger profit for the operator.

### SUMMARY OF THE INVENTION

The disclosed invention achieves its objectives through an innovative mechanism for forming bet-lines and bonus-lines. In one form of the invention a bet-line generating mechanism within probabilistic gaming device that accepts wagers on a per game basis and generates a payout based on one or more bet-lines which a player selects is comprised of a first reel containing a plurality of symbols. In addition, the bet-line generating mechanism contains a plurality of additional reels, where each of the additional reels contains a plurality of symbols. A first selection mechanism is coupled to the first reel, where the first selection mechanism is adapted to allow the player to select an indicator corresponding to a tile from the first reel, resulting in a first selected tile. An additional selection mechanism is coupled to the additional reels, where the additional selection mechanism is adapted to allow the player to select an indicator corresponding to a tile from one of the additional reels, thereby resulting in an additional selected tile. A bet-line generator, which is coupled to the first selection mechanism and the additional selection mechanism, generates a bet-line encompassing the first selected tile and any tiles contained in the additional reels whose position corresponds to the additional selected tile.

A different form of this invention is similar to the previous form, but includes the generation of a bonus line, which may be generated vertically across one reel, or horizontally across a number of reels. The bonus line, which is not selected by the player, but rather is automatically determined by the probabilistic gaming device, gives the player an additional probability of receiving a payout during each game played. The bonus line is played during the same games as the player's bet-line, thereby allowing the player to wager more during a given time-period.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a top plan view of the reels of a prior art probabilistic gaming device.

FIG. 2 is a picture view of a reel exhibition of one embodiment of the present invention.

FIG. 3 is a top plan view of the tile format of one embodiment of the present invention.

FIG. 4 is a top plan view of the tile format of one embodiment of the present invention, illustrating the formation of a bet-line.

FIG. 5 is a collection of top plan views of the tile format of one embodiment of the present invention, illustrating the formation of different bet-lines.

FIG. 6 is a top plan view of the tile format of one embodiment of the present invention, illustrating the formation of a bet-line where more tiles are present in the middle reels.

FIG. 7 is a top plan view of the tile format of one embodiment of the present invention, illustrating the formation of a bet-line where more tiles are present in the outer reels.

FIG. 8 is a collection of top plan views of the tile format of one embodiment of the present invention, illustrating the formation of different vertical bonus-lines.

FIG. 9 is a collection of top plan views of the tile format of one embodiment of the present invention, illustrating the formation of different horizontal bonus-lines

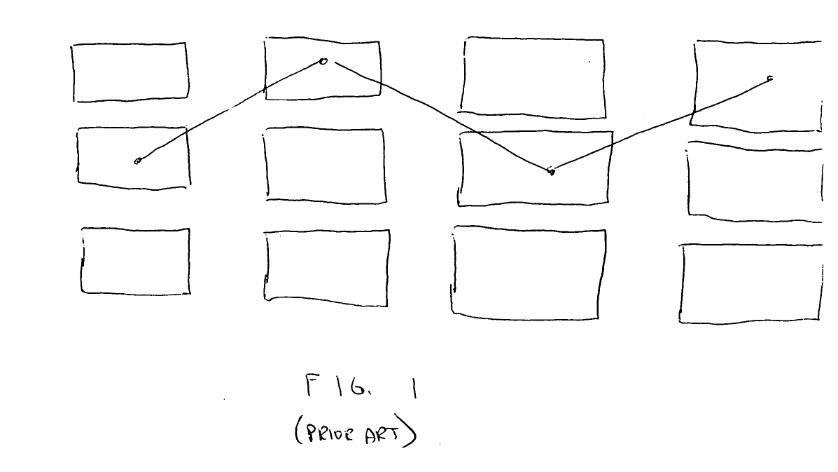

### DETAILED DESCRIPTION OF THE ILLUSTRATED EMBODIMENT

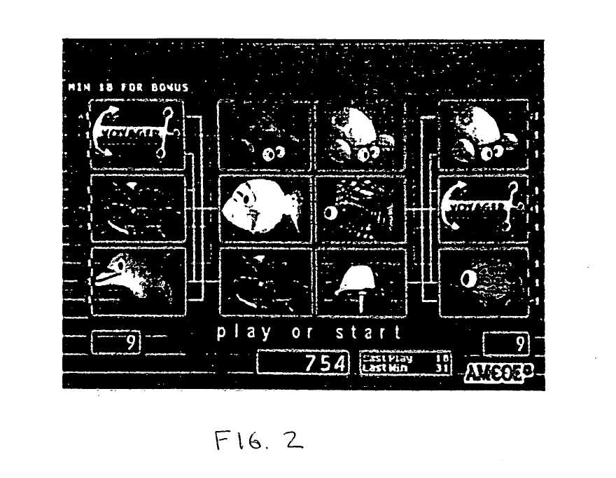

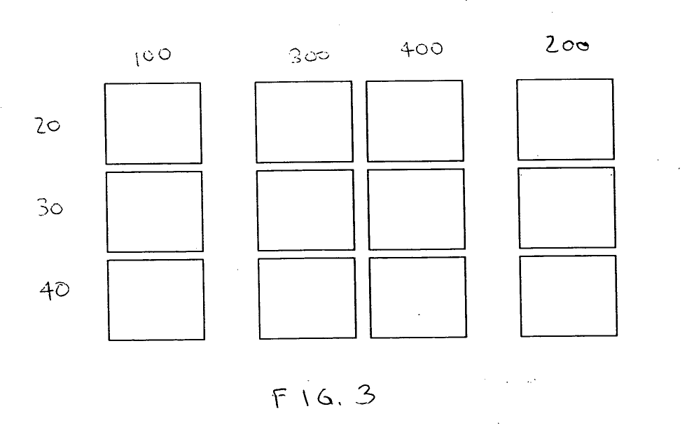

FIG. 2 illustrates an embodiment of the present invention. FIG. 3 shows this same embodiment in abstract form, where the tile format is more clearly visible. FIG. 3 shows an embodiment where four reels are used, including a left side leading reel 100, two center reels, 300 and 400, and a right side leading reel 200, where each reel displays three tiles. The tiles are organized into three rows, including a top row 20, a middle row 30, and a bottom row 40. As will be shown, this embodiment allows for up to eighteen simultaneous bet-lines to be played per game using the easily visualizable bet-line formation method of the disclosed invention.

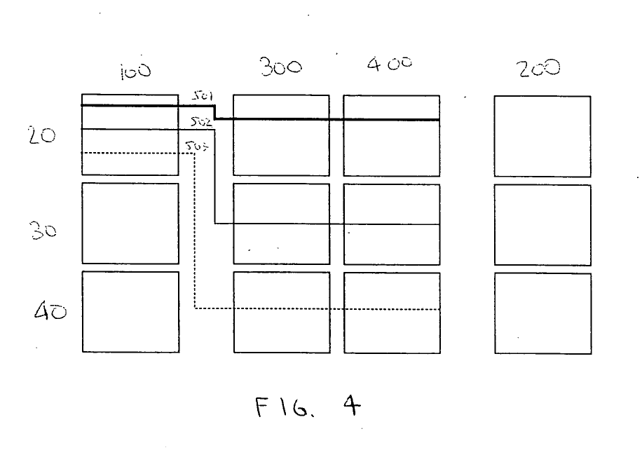

FIG. 4 illustrates the formation of a bet line using the method of the present invention. Starting from the left leading reel 100 a horizontal bet-line is formed. The first bet-line 501 encompasses the topmost tiles of reels 100, 300 and 400. The bet-line would be formed by the player selecting the tiles he wished to be in the bet-line. Some selection mechanisms that could be used are a touch screen on a computer driven probabilistic gaming machine or a grid of switches, where each switch represents a given tile that can be placed in the bet-line. As will be explained herein, the player does not necessarily have to select every tile that will be in the bet-line. Once a tile from a leading reel and a tile from one of the center reels has been selected, a mechanism within the probabilistic gaming device can fill out the bet-line.

A convenient way of expressing a bet-line is by listing the encompassed tiles in ordinate form. A tile is expressed in ordinate form by listing the row and reel within parenthesis; i.e.; the top-most tile of reel 100 could be expressed as (20,100). To further compact the notation, the bet-line can be expressed as a sequence of tiles in ordinate form separated by commas and within brackets; i.e.; the first bet-line 501 would be expressed as [(20,100),(20,300),(20,400)]. FIG. 4 shows two other bet-lines formed from tile (20,100). The second, labeled 502, could be expressed as [(20,100),(30,300),(30,400)]. The third, labeled 503, could be expressed as [(20,100),(40,300),(40,400)].

FIG. 5 shows the bet-lines that can be formed using the method explained herein with the tile format of FIG. 3. As can be seen, bet-lines can be formed from either the left side leading reel 100 or the right side leading reel 200, with the bet-lines extending into the center two reels, 300 and 400. This particular configuration allows for a total of 18 bet-lines, all of which are illustrated in FIG. 5.

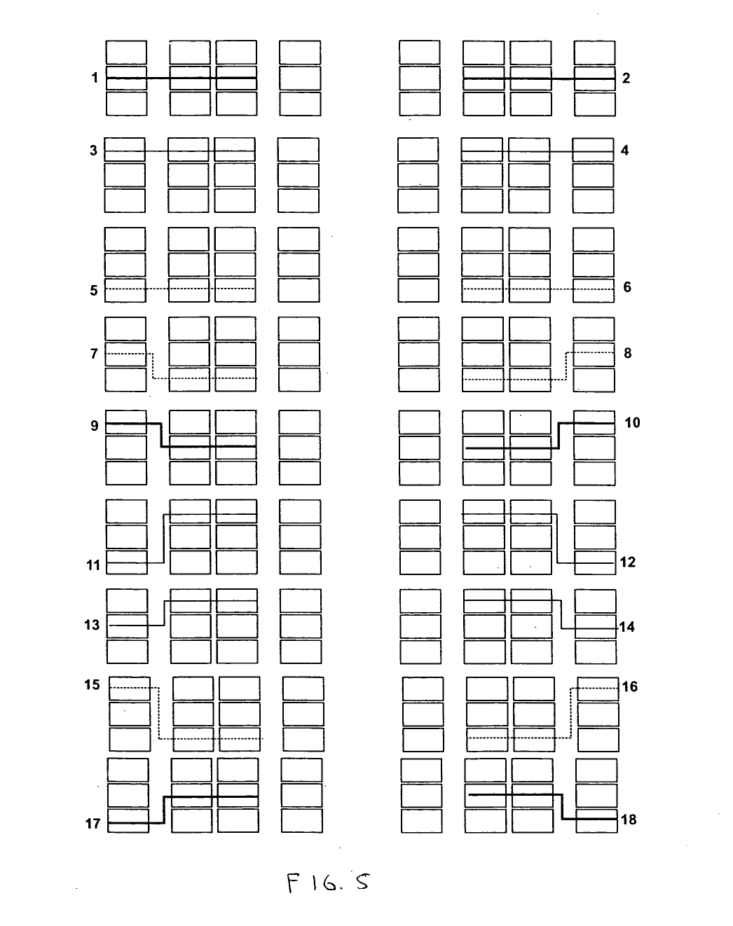

FIG. 6 shows an unbalanced configuration where the center reels have more tiles than the leading reels. In this particular configuration, each tile in the leading reels can form four bet lines, as there are four tiles in each of the center reels. Therefore, this particular configuration allows for a total of 24 bet-lines using the method disclosed herein.

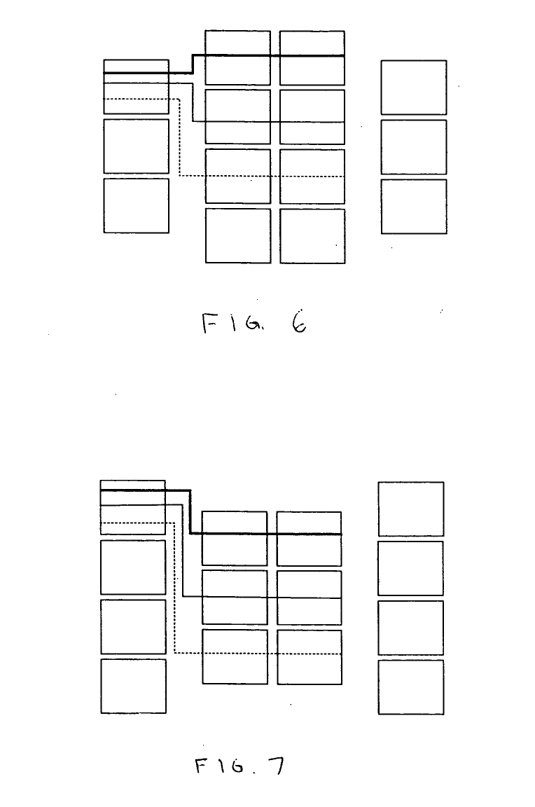

FIG. 7 shows another unbalanced configuration where the leading reels have more tiles than the center reels. In the configuration of FIG. 7, the leading reels have more tiles than the center reels. As there are three tiles in each center reel, each tile in a leading reel can form three bet-lines, allowing for a total of 24 bet-lines using the method disclosed herein.

Once a bet-line is selected, the player will activate the game. This can be accomplished by a pull lever, to “spin the reels,” or, in more modern computer based systems, can make use of a button that triggers a program to virtually spin reels maintained within the probabilistic gaming devices computer. The resultant placement of the tiles vis-à-vis the bet-line(s) the player entered determines whether and how much of a payout the player will receive.

Another important feature of this invention is the formation of bonus lines. A bonus line may be formed either vertically or horizontally. The tile configuration of a bonus line is not an exact re-use or duplicate of the tile configuration of any bet-line; hence, an additional probability within the same wagered game played is made possible. A particular configuration of tiles in the bonus line will result in a “winner,” and the player will receive a payout additional to any he may have received from the bet-lines he played. Bonus lines can be formed either horizontally or vertically. One tile configuration that probabilistic gaming devices may use to result in a payout is where all tiles in a row (i.e.; horizontal bonus line) are the same. Either vertical or horizontal bonus lines may rely on a particular sequence of tiles; for instance, if the probabilistic gaming device uses a card theme for its tiles, a straight or a flush across the bonus line may result in a payout. Note that this invention does not necessarily require that all tiles within a bonus line form a particular configuration; for instance, a payout may be won when two particular tiles are situated next to one another in a bonus line, even though the bonus line itself contains three or more tiles. Nor must a bonus line necessarily encompass every tile within a given row or column.

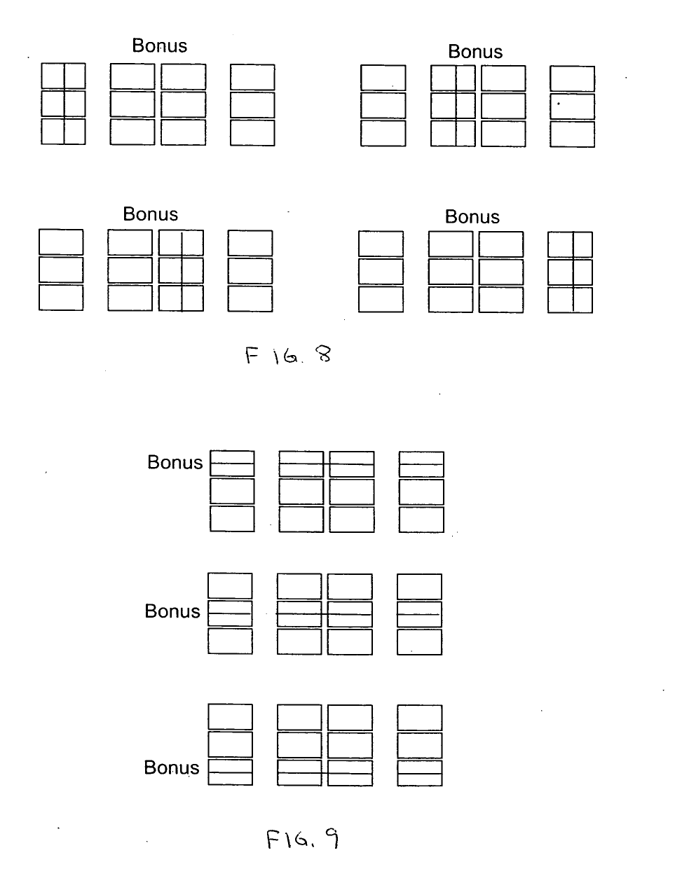

FIG. 8 depicts the formation of vertical bonus lines using the tile layout of FIG. 3. As there are four reels, a total of four vertical bonus lines can be formed.

FIG. 9 depicts the formation of horizontal bonus lines using the tile layout of FIG. 3. As can be seen, there is one horizontal bonus line for each row.

If an unbalanced tile configuration is used, such as those depicted in FIGS. 6 and 7, the formation of horizontal bonus lines becomes more complicated. Where the center reels contain more tiles than the leading reels, such as depicted in FIG. 6, one approach that may be used would be to match corresponding tiles in the leading rows to corresponding tiles in the center rows; for instance, the bottom tiles in the leading rows would be matched to the bottom tiles in the center rows, and the second tiles in the leading rows would be matched to the second tiles in the center rows. Another approach would be to match the top and bottom tiles in the leading reels to their corresponding tiles in the center reels, and then allow center tiles in the leading reels to match to multiple rows of tiles in the center reels; for instance, center tiles in the leading reels of FIG. 6 could match to both the second and third rows of tiles in the center reels. Where the leading reels have more tiles than the center reels, such as depicted in FIG. 7, one approach that could be used would be to match the top and bottom tiles of the leading reels to the corresponding rows of tiles in the center reels, and then match the multiple center tiles of leading reels with the single row of center tiles in the center reels.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

I claim:

1. A bet-line generating mechanism within a probabilistic gaming device that accepts one or more wagers per game and generates a payout based on at least one bet-line, the bet-line generating mechanism comprising:
i) a first reel, where the first reel contains a plurality of symbols;
ii) a plurality of additional reels, where the additional reels each contain a plurality of symbols;
iii) a first selection mechanism coupled to the first reel, the first selection mechanism adapted to allow the player to select an indicator corresponding to a tile from the first reel, resulting in a first selected tile;
iv) at least one additional selection mechanism, where the at least one additional selection mechanism is coupled to at least one of the plurality of additional reels, the at least one additional selection mechanism adapted to allow the player to select an indicator corresponding to a tile from the at least one of the plurality of additional reels, resulting in an additional selected tile, the tile having a position; and
v) a bet-line generator coupled to the first selection mechanism and coupled to the at least one additional selection mechanism, the bet-line generator generating a bet-line encompassing the first selected tile and any tiles contained in the at least one additional reels corresponding horizontally to the position of the additional selected tile.

2. The bet-line generating mechanism of claim 1, wherein the first reel and the plurality of additional reels display the same number of tiles.

3. The bet-line generating mechanism of claim 1, wherein the first selection mechanism and the at least one additional selection mechanism are the same selection mechanism.

4. The bet-line generating mechanism of claim 1, wherein the plurality of additional reels comprises a first additional reel, and a second additional reel.

5. The bet-line generating mechanism of claim 1, further comprising a bonus line generator that generates a bonus line corresponding to each game, wherein the bonus line results in additional probability of payout.

6. The bet-line generating mechanism of claim 5, wherein a bonus line is generated encompassing the tiles of the first reel.

7. The bet-line generating mechanism of claim 5, wherein a bonus line is generated encompassing the tiles of one of the plurality of additional reels.

8. The bet-line generating mechanism of claim 5, wherein a bonus line is generated encompassing tiles in corresponding positions of the first reel and the plurality of additional reels.

9. A method of building a bet-line in a probabilistic gaming device that accepts one or more wagers per game and generates a payout based on at least one bet-line, the method comprising the steps of:
i) selecting a position corresponding to a first tile from a first reel;
ii) selecting a position corresponding to an additional tile from one of a plurality of additional reels; and
iii) generating the bet-line encompassing the first tile and any tiles within the plurality of additional reels corresponding to the row of the additional tile.

10. The method of claim 9, further comprising the step of generating a bonus line, the bonus line resulting in additional probability of payout.

11. The method of claim 10, wherein the bonus line is generated encompassing the tiles of the first reel.

12. The method of claim 10, wherein the bonus line is generated encompassing the tiles of one of the plurality of additional reels.

13. The method of claim 10, wherein the bonus line is generated encompassing tiles in corresponding positions of the first reel and the plurality of additional reels.

14. A bet-line generating mechanism within a probabilistic gaming device that accepts one or more wagers per game and generates a payout based on at least one bet-line, the bet-line generating mechanism comprising:
i) means for selecting a position corresponding to a first tile from a first reel;
ii) means for selecting a position corresponding to an additional tile from one of a plurality of additional reels; and
iii) means for generating a bet-line encompassing the first tile and any tiles within the plurality of additional reels corresponding to the row of the additional tile.

15. The bet-line generating mechanism of claim 14, further comprising means for generating a bonus line, the bonus line resulting in additional probability of payout.

16. The bet-line generating mechanism of claim 15, wherein the bonus line is generated encompassing the tiles of the first reel.

17. The bet-line generating mechanism device of claim 15, wherein the bonus line is generated encompassing the tiles of one of the plurality of additional reels.

18. The bet-line generating mechanism of claim 15, wherein the bonus line is generated encompassing tiles in corresponding positions of the first reel and the plurality of additional reels.
